(19) United States
(12) Patent Application Publication
(10) Pub. No.: US 2012/0169444 A1
(43) Pub. Date: Jul. 5, 2012

(54) LAMINATED INDUCTOR AND METHOD OF MANUFACTURING THE SAME

(75) Inventors: Soo Hwan Son, Seoul (KR); Sung Yong An, Anyang (KR); Sung Lyoung Kim, Bucheon (KR); Jin Woo Hahn, Yongin (KR); Ic Seob Kim, Yongin (KR)

(73) Assignee: SAMSUNG ELECTRO-MECHANICS CO., LTD.

(21) Appl. No.: 13/305,396

(22) Filed: Nov. 28, 2011

(30) Foreign Application Priority Data
Dec. 30, 2010 (KR) 10-2010-0139233

(51) Int. Cl. H01F 27/255; H01F 41/00

(52) U.S. Cl. 336/83; 156/89.12

(57) ABSTRACT

There is provided is a laminated inductor, including: a ceramic main body in which a plurality of ceramic layers are stacked; a plurality of inner electrodes formed on the plurality of ceramic layers and having a contact area with the ceramic layer that is 10% or less than that of the entire area of the ceramic layer; and via electrodes having a coil structure by connecting the plurality of inner electrodes.

### CROSS-REFERENCE TO RELATED APPLICATIONS

This application claims the priority of Korean Patent Application No. 10-2010-0139233 filed on Dec. 30, 2010, in the Korean Intellectual Property Office, the disclosure of which is incorporated herein by reference.

### BACKGROUND OF THE INVENTION

1. Field of the Invention

The present invention relates to a laminated inductor and a method of manufacturing the same, and more particularly, to a laminated inductor having improved electrical characteristics by reliving a residual stress between an inner electrode and a layer therein.

2. Description of the Related Art

An inductor, an important passive device in the configuration of an electronic circuit, together with a resistor and a capacitor, has been used as a component to remove noise or configure an LC resonance circuit.

The inductor may be manufactured by winding a coil around a ferrite core or printing and forming electrodes on both ends thereof. Further, the inductor may be manufactured by printing and stacking inner electrodes on a magnetic material or a dielectric material.

The inductor may be classified as one of several types such as a laminated type, a winding type, a thin film type, or the like. Among these, a laminated inductor has been prominent.

A general laminated inductor has a structure in which a plurality of magnetic layers formed with inner conductive patterns thereon are stacked. The inner conductive patterns are sequentially connected through via electrodes formed on each magnetic layer to generally have a coil structure, thereby implementing characteristics such as targeted inductance, impedance, or the like.

The laminated inductor is manufactured by printing the inner electrodes on an existing ceramic layer and stacking the ceramic layers printed with the inner electrodes.

The reliability of products is degraded due to the increased number of stacked layers and the residual stress between the ceramic layer and the inner electrode with the progress of miniaturization.

For example, the inner electrode and the ceramic layer may be deformed due to residual stress between the inner electrode and the ceramic layer, such that the defects of the laminated inductor such as shorts of the inner electrodes formed on different layers can be caused.

### SUMMARY OF THE INVENTION

An aspect of the present invention provides a laminated inductor with improved reliability of products by relieving a residual stress between an inner electrode and a ceramic layer.

According to an aspect of the present invention, there is provided a laminated inductor, including: a ceramic main body in which a plurality of ceramic layers are stacked; a plurality of inner electrodes formed on the plurality of ceramic layers and having a contact area with the ceramic layer that is equivalent to an area of 10% or less than that of the entire area of the ceramic layer; and via electrodes having a coil structure by connecting the plurality of inner electrodes.

A gap may be formed between the ceramic layer and the inner electrode; and the gap may be formed by firing the resin layer.

The coil structure formed by the inner electrode may have an impedance value of 500Ω or more in a direct circuit resistance (DCR) of 250 mΩ or more.

The laminated inductor may further include a first outer electrode and a second outer electrode formed on both end surfaces of the ceramic main body and connected to both ends of the coil structure.

According to another aspect of the present invention, there is provided a method of manufacturing a laminated inductor, including: forming an inner electrode on a ceramic layer made of a dielectric material; forming a resin layer made of resin having a combustion temperature lower than a sintering temperature of the ceramic layer on the inner electrode; forming a ceramic laminate by stacking the ceramic layers on which the inner electrodes and the resin layers are formed; and firing the resin layer by firing the ceramic laminate.

The method of manufacturing a laminated inductor may further include, prior to forming the inner electrode, forming a resin layer made of a resin having a combustion temperature lower than a sintering temperature of the ceramic layer, on a position in which an inner electrode is to be formed on the ceramic layer formed of a dielectric material.

According to another aspect of the present invention, there is provided a method of manufacturing a laminated inductor, including: forming, on a position in which an inner electrode is formed on a ceramic layer made of a dielectric material, a resin layer made of resin having a combustion temperature lower than a sintering temperature of a ceramic layer; forming the inner electrode on the resin layer; forming a ceramic laminate by stacking the ceramic layers on which the inner electrodes and the resin layers are formed; and firing the resin layer by firing the ceramic laminate.

A contact area of the ceramic layer and the inner electrode may be maintained to be 10% or less than that of an entire area of the ceramic layer by firing the resin layer.

The resin layer may include a resin powder made of an acrylic-based and styrene-based polymer.

A particle diameter of the resin powder may be controlled according to a thickness of the resin layer.

The particle diameter of the resin powder may be 0.1 to 5.0 μm.

The resin layer may be formed by a resin paste including vehicles made of at least one of a group consisting of an acrylic, an ethyl cellulose, and a butyral resin.

The viscosity of the resin paste may be 1000 to 50000 cps.

The forming of the resin layer may be formed by printing a resin paste made of resin particles.

The resin paste may be printed by a screen printing method or a gravure printing method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a laminated inductor according to an exemplary embodiment of the present invention;

FIG. 2 is a cross-sectional view of the laminated inductor according to the exemplary embodiment of the present invention;

FIG. 3 is a partially enlarged view showing a cross section of the laminated inductor according to Comparative Example of the present invention; and

FIG. 4 is an enlarged view of a portion showing a cross section of the laminated inductor according to the exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

In addition, unless explicitly described to the contrary, the word “comprise” and variations such as “comprises” or “comprising,” will be understood to imply the inclusion of stated elements but not the exclusion of any other elements.

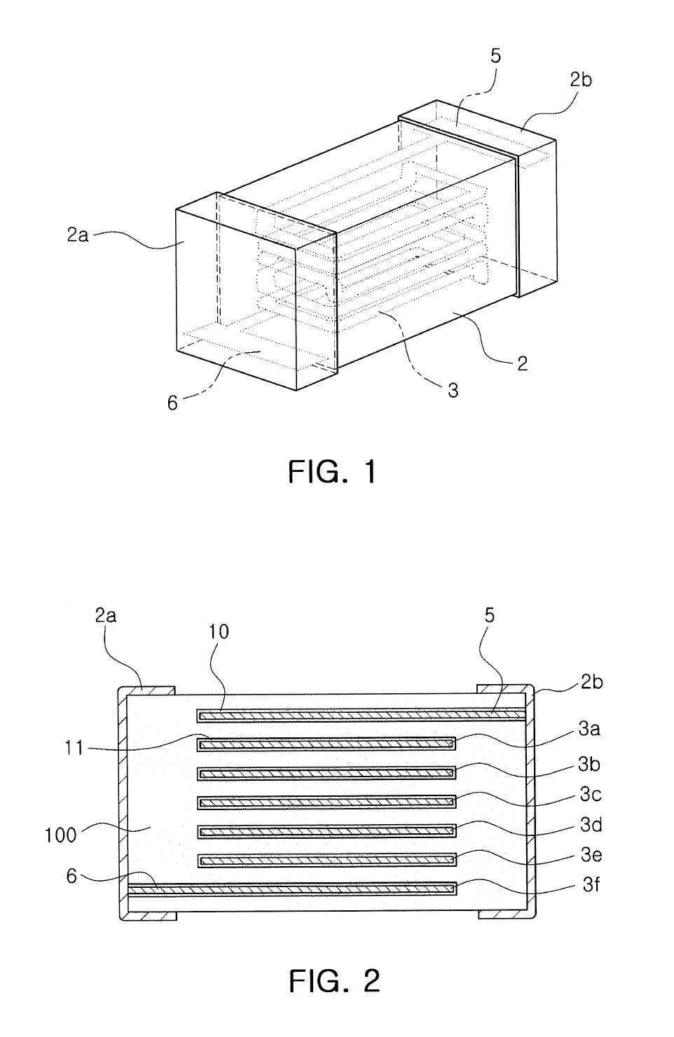

FIG. 1 is a perspective view of a laminated inductor according to an exemplary embodiment of the present invention.

A laminated inductor according to an exemplary embodiment of the present invention may include a ceramic main body in which a plurality of ceramic layers are stacked; a plurality of inner electrodes 3 formed on the plurality of ceramic layers and having a contact area with the ceramic layer that is equivalent to an area of 10% or less than that of the entire area of the ceramic layer; and via electrodes having a coil structure by connecting the plurality of inner electrodes 3 to one another.

The laminated inductor according to the exemplary embodiment of the present invention, which has a terminal type, may include a main body 2 having a structure in which a plurality of magnetic layers made of dielectric material or non-magnetic layers are stacked, and a first outer electrode 2a and a second outer electrode 2b formed on two end faces of the main body 2. In the main body, the inner electrode 3 is formed on the ceramic layer, and respective inner electrodes 3 are connected to each other through via electrodes to generally have a coil structure. Output terminals 5 and 6 formed at the ends of the inner electrode are exposed to the outside and are connected to outer electrodes.

Therefore, the laminated inductor having the structure of coil connected to the outer electrodes while being disposed in the ceramic laminate is prepared

Referring to FIG. 1, the ceramic laminate configuring the laminated inductor may include the inner electrodes 3 formed on the plurality of ceramic layers, and the inner electrodes 3 may be connected to one another by a connection terminal constructed of a plurality of via electrodes to form the coil structure.

The main body 2 according to the exemplary embodiment of the present invention may be configured by the ceramic laminate formed by stacking a plurality of ceramic layers, wherein the plurality of ceramic layers may be formed with the inner electrodes 3.

The ceramic layers configuring the main body 2 may be made of dielectric, but is not limited thereto, and may be made of a magnetic material, but is not limited thereto. However, in case of forming a gap layer, the ceramic layer may be made of a non-magnetic material.

In the exemplary embodiment of the present invention, ferrite may be used as the magnetic material and the ferrite may be appropriately selected according to magnetic characteristics required for electronic components, but ferrite having a relatively large specific resistance and relatively low loss maybe used. Without being limited thereto, Ni—Zu—Cu-based ferrite may be used and a dielectric material having a dielectric constant of 5 to 100 may be used.

Further, as the non-magnetic dielectric material, a ceramic material made of zirconium silicates, potassium zirconate, zirconium, or the like, may be used, but is not limited thereto.

When the laminated inductor is configured of the ceramic layer made of a magnetic material or a non-magnetic material, the difference in coefficients of linear expansion may be small according to a selected material.

The ceramic layer may be formed with the plurality of inner electrodes 3. The inner electrodes 3 maybe formed in the main body 1 to receive electricity so as to implement inductance or impedance.

The inner electrode 3 may be made of a conductive material and may be made of an inexpensive material having low resistivity. The inner electrode 3 may be made of at least one of Ag, Pt, Pd, Cu, Au, and Ni or an alloy thereof, but is not limited thereto.

According to the exemplary embodiment of the present invention, a contact area between the ceramic layer and the inner electrode 3 may be maintained to be 10% or less than that of the entire area of the ceramic layer, thereby preventing a residual stress from being formed between the inner electrode 3 and the ceramic layer.

FIG. 2 is a cross-sectional view of the laminated inductor according to the exemplary embodiment of the present invention.

The laminated inductor according to the exemplary embodiment of the present invention may include ceramic main body in which a plurality of ceramic layers are stacked; a plurality of inner electrodes 3a, 3b, 3c, 3d, 3e, 3f, 5, and 6 formed on the plurality of ceramic layers; a gap 11 formed between the ceramic layer and the inner electrode; and via electrodes connecting the plurality of inner electrodes to one another to provide a coil structure therefor.

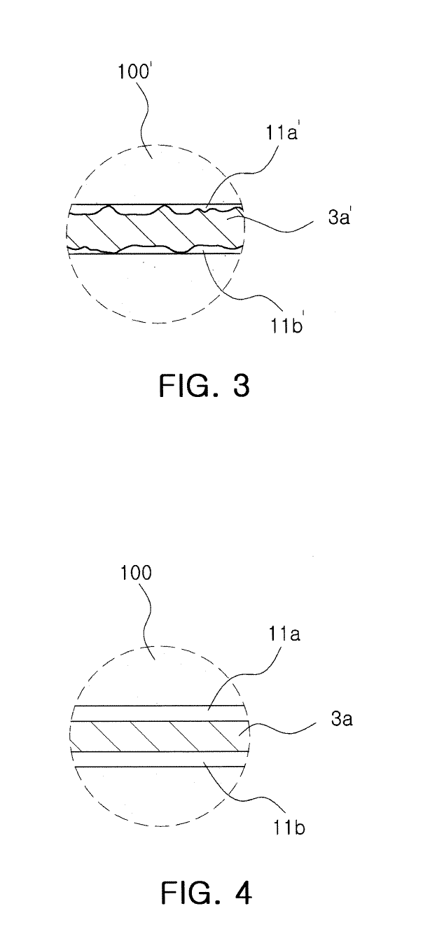

FIG. 3 is a partially enlarged view of the laminated inductor according to Comparative Example of the present invention.

In case of Comparative Example of the present invention, the inner electrode having resin particles formed between the ceramic layers is manufactured by firing the resin particles.

According to Comparative Example of the present invention, when an inner electrode paste forming the inner electrode includes resin, the stress of a plastic body may be reduced by suppressing the bonding between an inner electrode 3a′ and a ceramic layer 100′.

However, as shown in FIG. 3, the inner electrode may have a porous shape by firing and removing the resin particles included in the inner electrode 3a′. That is, a shape of spaces 11a′ and 11b′ formed between the inner electrode and the ceramic layer is irregular due to the firing of the resin particles. In addition, since the resin particles are included in the inner electrode, a direct circuit resistance (DCR) value of the inner electrode is increased.

However, referring to FIG. 4 according to the exemplary embodiment of the present invention, since a resin layer to cover the inner electrode is formed without including the resin particles in the inner electrode, the bonding between the inner electrode 3a and the ceramic layer 100 may be suppressed and the stress of the plastic body may be reduced.

Referring to FIG. 3 according to Comparative Example of the present invention, the adhesion between the ceramic layer 100′ and the inner electrode 3a′ maybe improved to some degrees since the resin particles included in the inner electrode are partially fired, but the remaining portion still is in contact with the ceramic layer to cause the residual stress since the resin particles are partially fired and removed.

That is, the contact area between the ceramic layer and the inner electrode may be approximately 50% or more than that of the entire area of ceramic layer. Since only the portion in which the resin particles are included in the inner electrode is fired and removed, the contact area of the inner electrode and the resin particles may be approximately 50% or more.

Therefore, in the portion corresponding to the remaining 50%, the ceramic layer is partially in contact with the inner electrode and the residual stress remains in the partially contacting portion.

Further, since the resin particles are fired and removed even in the inner electrode, the inside of the inner electrode has a porous structure like basalt. Therefore, the strength of the inner electrode may be degraded, such that it may be partially affected by the residual stress due to the degradation in strength even though the residual stress with the ceramic layer is reduced.

However, according to the exemplary embodiment of the present invention, the resin layer including the resin particles is formed between the ceramic layer 100 and the inner electrode 3a. Since the resin particles have temperature lower than the sintering temperature of the ceramic layer, the resin particles are fired and removed when the ceramic layer is sintered and the space between the ceramic layer 100 and the inner electrode 3a remains as gaps 11a and 11b.

According to the embodiment of the present invention, the inner electrode may be maintained as the densified structure since the inner electrode does not include the resin particles. Therefore, the residual stress between the ceramic layer 100 and the inner electrode 3a may be prevented while maintaining the strength of the inner electrode.

Further, the contact area of the inner electrode 3a and the ceramic layer may become 10% or less than that of the entire area of the ceramic layer 100.

That is, since the gap is formed by removing the resin layer existing between the inner electrode 3a and the ceramic layer 100, the inner electrode 3a may have a uniform surface shape and thus, the contact area may be maintained to be 10% or less than that of the entire area of the ceramic layer 100.

Further, since the resin particles are not included in the inner electrode 3a, the inner electrode 3a has excellent electrical conductivity and thus, the direct circuit resistance (DCR) may be maintained to be a relatively low value.

According to the exemplary embodiment of the present invention, the coil structure formed by the inner electrode may have an impedance value of 500Ω or more in the direct circuit resistance (DCR) of 250 mΩ or more.

That is, in the case of the laminated inductor manufactured according to the exemplary embodiment of the present invention, the direct circuit resistance in the inner electrode may be maintained to be relatively small, such that the coil structure including the inner electrode as described above may significantly increase the ratio of space formed between the inner electrode and the ceramic layer, thereby improving the impedance characteristics of the coil without the loss of the direct circuit resistance.

Hereinafter, a method of manufacturing a laminated inductor having the gap will be described.

According to the exemplary embodiment of the present invention, the method of manufacturing a laminated inductor in which a gap 11a is formed on the top surface of the inner electrode may include: forming the inner electrode on the ceramic layer made of a dielectric material; forming on the inner electrode the resin layer made of resin having the combustion temperature lower than the sintering temperature of the ceramic layer; forming the ceramic laminate by stacking ceramic layers on which the inner electrodes and the resin layers are formed; and firing the resin layer by firing the ceramic laminate.

Further, the method of manufacturing a laminated inductor may further include forming, on a position in which the inner electrode is to be formed, the resin layer made of resin having the combustion temperature lower than the sintering temperature of the ceramic layer, prior to the forming of the inner electrode. By the method, the resin layers for forming the gaps 11a and 11b may be formed on the top surface and the bottom surface of the inner electrode.

Further, the laminated inductor having the gap 11b formed on the bottom surface thereof may be manufactured by forming the resin layer on the bottom surface of the inner electrode.

In order to manufacture the laminated inductor formed with the gaps according to the exemplary embodiment of the present invention, the plurality of ceramic layers are prepared.

The ceramic layer may be made of a magnetic material as an insulating material and may be made of a non-magnetic material in the case of forming a gap layer.

According to the exemplary embodiment of the present invention, the ferrite may be used as the magnetic material and the ferrite may be appropriately selected according to the magnetic characteristics required as the electronic components, and the ferrite having a relatively large specific resistance and relatively low loss may be used. As the example, the Ni—Zu—Cu-based ferrite may be used, but is not limited thereto.

The ceramic layer is provided with the inner electrode formed thereon. The inner electrode may be made of a conductive material and may be made of an inexpensive material having low resistivity. The inner electrode 3 may be made of at least one of Ag, Pt, Pd, Cu, Au, and Ni or an alloy thereof, but is not limited thereto.

The resin layer may be formed on the ceramic layer formed with the inner electrode. The material forming the resin layer may be a material removed by the firing, and may be a material having a combustion temperature lower than a firing temperature of the ceramic layer.

The resin layer is not limited thereto, but a resin powder made of an acrylic and styrene-based polymer may be used for forming the resin layer. The resin powder may be 0.1 to 5.0 μm to have the approximate combustion temperature, but is not limited thereto. Alternatively, the size of the resin powder may be changed according to the resin layer to be applied, that is, the size of the gap to be formed.

According to the exemplary embodiment of the present invention, the resin powder may be manufactured as a resin paste by being mixed with vehicles such as an acrylic, an ethyl cellulose, a butyral resin, or the like and performing a dispersion process such as 3-roll-mill, or the like, on the mixture, but is not limited thereto.

In the resin paste according to the embodiment of present invention, the amount and composition of vehicles may be controlled to have appropriate viscosity according to the printing method. The resin paste may be controlled to have the viscosity of 1000 to 50000 cps, but is not limited thereto. Therefore, the resin paste may be controlled to have the appropriate viscosity according to the printing method and the printing environment.

The resin paste may be formed on the top portion, the bottom portion, or the top and bottom portions of the inner electrode by various printing methods. The resin paste may be formed on the inner electrode formed on the ceramic layer by a screen printing method, a gravure printing method, or the like, but is not limited thereto.

According to another exemplary embodiment of the present invention, the resin paste is first printed on the ceramic layer to form the lower resin layer, and the lower resin layer may be formed between the inner electrode and the ceramic layer by printing the inner electrode thereon.

Further, according to another exemplary embodiment of the present invention, the ceramic layer formed with an upper resin layer and a lower resin layer may be provided by forming the lower resin layer by printing the resin paste on the ceramic layer, printing the inner electrode, and again printing the upper resin layer on the inner electrode.

By the above-mentioned method, the ceramic laminate may be manufactured by stacking a plurality of ceramic layers on which the resin layers and the inner electrodes are formed.

The inner electrode may be formed in the ceramic laminate, and the resin layer may be formed on the top portion or the bottom portion, or the top and bottom portions of the inner electrode. Since the resin layer can prevent the bonding between the ceramic laminates, the short or open of the inner electrode due to the bonding of the ceramic plastic body can be prevented.

When the ceramic laminate is fired, the gap may be formed from the resin layer formed on the top portion, the bottom portion, or the top and bottom portions of the inner electrode. Since the gap is formed by firing the resin layer, the gap may be formed in a uniform and constant size, such that the deformation of the inner electrode and the ceramic layer can be prevented.

In addition, since the resin is not included in the inner electrode, the resistance of the inner electrode is not increased due to the resin particles, such that the resistance of the inner electrode may be constantly maintained. Therefore, the resistance value is increased even though the high current is applied, such that the loss of the electrical characteristics of the laminated inductor can be prevented.

The laminated inductor according to the exemplary embodiment of the present invention may suppress a direct contact between the inner electrode and the ceramic layer, such that the occurrence of stress due to the bonding between two materials can be prevented. In addition, since the resin particles are formed on the top and bottom portions of the inner electrode, the loss of electrical characteristics of the device can be prevented and thus, the electrical characteristics may be improved.

Further, since the resin layer is formed outside the inner electrode, the densified structure of the laminated inductor may be formed and maintained, thereby improving the reliability of products.

The resin layer according to the exemplary embodiment of the present invention may also be applied to the inductor products requiring the relatively low resistance and the relatively high current characteristics without affecting the electrical characteristics and may also be applied to various printing methods, thereby increasing the flexibility during the manufacturing process of products.

A thickness of the resin layer may be controlled by controlling the size of the resin particles, the viscosity of the resin paste, or the like, such that the resin layer may be applied to various types of laminated inductors.

According to the exemplary embodiment of the present invention, the ceramic laminate including the resin layer may be fired and removed at 800 to 1000° C.

Therefore, the gaps 11a and 11b are formed in the space in which the resin layer is formed, which may reduce the residual stress between the resin layer and the ceramic layer.

According to Comparative Example of the present invention, the inner electrode may be formed by including resin particles in inner electrode paste for forming the inner electrode. In this case, the resin particles included in the inner electrode may be partially fired and removed, such that the contact area between the inner electrode and the ceramic layer becomes approximately 50% than that of the entire ceramic layer area, thereby reducing the residual stress.

However, the inner electrode itself has a porous structure like basalt by partially firing the resin particles included therein to degrade strength of the inner electrode, and includes the resin particles to increase the direct circuit resistance.

Therefore, the coil structure formed as the inner electrode according to Comparative Example increases the direct circuit resistance value when the impedance value is improved.

Since the strength of the inner electrode is degraded even though the residual stress is reduced, the short phenomenon due to the residual stress partially remaining in the inner electrode may occur.

Meanwhile, according to the exemplary embodiment of the present invention, the resin layer may be formed between the inner electrode and the ceramic layer to reduce the contact area between the inner electrode and the ceramic layer to 10% or less, thereby remarkably reducing the residual stress.

Further, since the resin particles are not included in the inner electrode, the direct circuit resistance value of the inner electrode may be maintained to be relatively low, such that the laminated inductor having the large impedance while maintaining the relatively low resistance value may be manufactured even though the coil structure is adapted.

That is, the laminated inductor having strong durability while improving the electrical characteristics may be manufactured.

### EXAMPLE

The inner electrode was formed on the ceramic layer and the resin layer was formed to have a thickness of 2 to 5 μm before and/or after the inner electrode was formed.

In the cases of Comparative Examples 1, 4, and 7 of the present invention, results of forming and firing the inner electrode by including the resin particles in the inner electrode paste were compared to one another.

The paste having a shrinkage of the inner electrode paste forming the inner electrode to be set to approximately 25% was used and was fired at 860, 880, and 900° C., respectively, to calculate the ratio of contact area of the ceramic layer and the inner electrode with respect to the entire area of the ceramic layer, thereby comparing the occurrence strength of the residual stress.

TABLE 1

| | FIRING | | |
|---|---|---|---|
| | TEMPERATURE | RESIN PARTICLE | RATIO OF CONTACT |
| NO. | (° C.) | LAYER (μm) | AREA (%) |
| 1 | 860 | — | 48 |
| 2 | 860 | 2.0 | 6 |
| 3 | 860 | 5.0 | 2 |
| 4 | 880 | — | 65 |
| 5 | 880 | 2.0 | 8 |
| 6 | 880 | 5.0 | 5 |
| 7 | 900 | — | 77 |
| 8 | 900 | 2.0 | 10 |
| 9 | 900 | 5.0 | 8 |

According to Comparative Example, it could be appreciated that the contact area of approximately 50% or more was formed and thus, the residual stress remained even though the resin particles are provided.

According to the exemplary embodiment of the present invention, when the resin particle layer is formed between the ceramic layer and the inner electrode, it could be appreciated that the inner electrode is maintained to have the contact area of 10% or less than that of the entire area of the ceramic layer.

Therefore, according to the exemplary embodiment of the present invention, the electrical characteristics of the laminated inductor may be improved while reducing the residual stress between the ceramic layer and the inner electrode.

As set forth above, the exemplary embodiment of the present invention may relieve the residual stress between the inner electrode and the ceramic layer, thereby providing the laminated inductor with the improved reliability of products.

The exemplary embodiment of the present invention may relieve the residual stress by lowering a contact ratio between the inner electrode and the ceramic layer, thereby providing the laminated inductor capable of improving the impedance characteristics without the loss of the DC circuit resistance and the method of manufacturing the same.

While the present invention has been shown and described in connection with the exemplary embodiments, it will be apparent to those skilled in the art that modification and variation can be made withough departing from the spirit and scope of the invention as defined by the appended claims.

What is claimed is:

1. A laminated inductor, comprising:
a ceramic main body in which a plurality of ceramic layers are stacked;
a plurality of inner electrodes formed on the plurality of ceramic layers and having a contact area with the ceramic layer that is equivalent to an area of 10% or less than that of the entire area of the ceramic layer; and
via electrodes having a coil structure by connecting the plurality of inner electrodes.

2. The laminated inductor of claim 1, wherein the ceramic layer and the inner electrode are provided with a gap formed therebetween; and the gap is formed by firing the resin layer.

3. The laminated inductor of claim 1, wherein the coil structure formed by the inner electrode has an impedance value of 500Ω or more in a direct circuit resistance (DCR) of 250 mΩ or more.

4. The laminated inductor of claim 1, further comprising a first outer electrode and a second outer electrode formed on both end surfaces of the ceramic main body and connected to both ends of the coil structure.

5. A method of manufacturing a laminated inductor, comprising:
forming an inner electrode on a ceramic layer made of a dielectric material;
forming a resin layer made of resin having a combustion temperature lower than a sintering temperature of the ceramic layer on the inner electrode;
forming a ceramic laminate by stacking the ceramic layers on which the inner electrodes and the resin layers are formed; and
firing the resin layer by firing the ceramic laminate.

6. The method of claim 5, further comprising, prior to forming the inner electrode,
forming the resin layer made of a resin having a combustion temperature lower than a sintering temperature of the ceramic layer, on a position in which the inner electrode is to be formed on the ceramic layer formed of a dielectric material.

7. A method of manufacturing a laminated inductor, comprising:
forming, on a position in which an inner electrode is formed on a ceramic layer made of a dielectric material, a resin layer made of resin having a combustion temperature lower than a sintering temperature of a ceramic layer;
forming the inner electrode on the resin layer;
forming a ceramic laminate by stacking the ceramic layers on which the inner electrodes and the resin layers are formed; and
firing the resin layer by firing the ceramic laminate.

8. The method of claim 5, wherein a contact area of the ceramic layer and the inner electrode is maintained to be 10% or less than that of an entire area of the ceramic layer by firing the resin layer.

9. The method of claim 5, wherein the resin layer includes a resin powder made of an acrylic-based and styrene-based polymer.

10. The method of claim 5, a particle diameter of the resin powder is controlled according to a thickness of the resin layer.

11. The method of claim 5, wherein the particle diameter of the resin powder is 0.1 to 5.0 μm.

12. The method of claim 5, wherein the resin layer is formed by a resin paste including vehicles made of at least one of a group consisting of an acrylic, ethyl cellulose, and a butyral resin.

13. The method of claim 12, wherein the viscosity of the resin paste is 1000 to 50000 cps.

14. The method of claim 5, wherein the forming of the resin layer is formed by printing a resin paste made of resin particles.

15. The method of claim 14, wherein the resin paste is printed by a screen printing method or a gravure printing method.

16. The method of claim 7, wherein a contact area of the ceramic layer and the inner electrode is maintained to be 10% or less than that of an entire area of the ceramic layer by firing the resin layer.

17. The method of claim 7, wherein the resin layer includes a resin powder made of an acrylic-based and styrene-based polymer.

18. The method of claim 7, a particle diameter of the resin powder is controlled according to a thickness of the resin layer.

19. The method of claim 7, wherein the particle diameter of the resin powder is 0.1 to 5.0 μm.

20. The method of claim 7, wherein the resin layer is formed by a resin paste including vehicles made of at least one of a group consisting of an acrylic, ethyl cellulose, and a butyral resin.

21. The method of claim 20, wherein the viscosity of the resin paste is 1000 to 50000 cps.

22. The method of claim 7, wherein the forming of the resin layer is formed by printing a resin paste made of resin particles.

23. The method of claim 22, wherein the resin paste is printed by a screen printing method or a gravure printing method.
